(19) United States
(12) Patent Application Publication
(10) Pub. No.: US 2014/0030392 A1
(43) Pub. Date: Jan. 30, 2014

(54) PROCESSING AND PACKAGING MEAT WITHOUT USING HIGHLY ABSORBENT MATERIAL

(71) Applicant: Chris J. TOPPS, Rancho Cucamonga, CA (US)

(72) Inventor: Chris J. TOPPS, Rancho Cucamonga, CA (US)

(73) Assignee: QST Ingredients and Packaging, Inc., Rancho Cucamonga, CA (US)

(21) Appl. No.: 14/047,739

(22) Filed: Oct. 7, 2013

Related U.S. Application Data
(63) Continuation of application No. 12/825,133, filed on Jun. 28, 2010, now abandoned.

(51) Int. Cl. A23B 4/02

(52) U.S. Cl. CPC A23B 4/02
USPC 426/125; 426/641; 426/644; 426/645; 426/129; 426/310; 426/281

(57) ABSTRACT

The present invention is in the field of meat processing and packaging. Specifically, the invention is a packaged uncooked treated meat product with increased moisture retention, thereby eliminating the need for highly absorbent material in the package.

### TECHNICAL FIELD

The present invention is in the field of meat processing and packaging. Specifically, the invention is a packaged uncooked meat product with increased moisture retention, thereby eliminating the need for highly absorbent material in the package.

### BACKGROUND OF THE INVENTION

The body of a living animal consists of about 70-80% water by weight. A majority of the water is bound to the musculature (i.e., the “meat”) through polar interactions with myofibrillar proteins in the muscle tissue. The amount of water retention depends on a variety of factors, such as: the animal species; age at slaughter; the type of muscle fiber; the available space within the myofibrillar structure; activity of muscle enzymes involved in proteolysis and lipolysis during aging; and the pH reached prior to and following rigor mortis. Once an animal is slaughtered, the meat begins losing water. By the time the meat is processed and packaged, water loss can be significant. The resulting loss of weight results in a lower economic return and often makes the meat tougher and less flavorful.

There are a number of meat processing methods for reducing spoilage and enhancing the appearance and flavor of the meat. One of the most common processing methods is the use of marinades. However, marinades are generally utilized to introduce a desired flavor to the meat and do not significantly reduce moisture loss.

Another meat processing method is the application of alkylating agents that increase the pH of the meat and thereby decrease glycolysis. The increased pH creates an environment that minimizes microbial colonization and thereby reduces spoilage. See, for example, U.S. Pat. Nos. 6,899,908 and 6,713,108. Unfortunately, this processing method by itself can result in diminished water retention and reduced storage stability.

The application of phosphates is another method of processing meat. The phosphates act as a buffer, maintaining a relatively high pH, which assists in water retention. U.S. Pat. No. 4,818,548 describes a method of treating fresh meat with a composition containing phosphate. The phosphate postpones spoilage resulting from microbial deterioration, and also aids in color retention. However, phosphate treatments have a tendency to diminish the appearance, texture and flavor of meat. Phosphate treated meats are often considered “over-processed” or having a “processed look and/or taste,” which is generally undesirable.

The application of sodium carbonate in a vacuum is another method of processing meat. Sodium carbonate, like phosphates, serves as a pH buffer (U.S. Pat. No. 5,939,112). However, sodium carbonate has been described as being less effective for enhancing water retention in meat than other processing methods such as alkali silicates (U.S. Pat. No. 7,001,630).

Other meat processing methods include the application of trehalose to decrease shrinkage during cooking (U.S. Pat. Appl. No. US 2004/0219283), sodium bicarbonate as an injectable treatment to reduce the rate of pH decline (U.S. Pat. No. 6,020,012) and sodium bicarbonate in a vacuum to reduce the number of holes in cooked meat (U.S. Pat. No. 7,060,309).

In general, meat that retains moisture during storage also retains flavor, tenderness and juiciness. This is true for all meat products including beef, pork and poultry, whether or not the moisture is natural or added during processing. In the retail industry, post-packaging moisture loss is “masked” from the consumer by placing a highly absorbent “soaker pad” between the meat and the packaging tray to absorb this moisture. A significant disadvantage of this practice is the contamination that can result from contact with the used absorbent material, excess packaging waste and increased packaging costs. Other problems include the tendency for the absorbent material to leave fibers on the meat, or to remain adhered to the meat when it is taken from the tray and cooked. In addition, the absorbent pad is often manufactured from a different material than the tray itself, thus making recycling more difficult.

Accordingly, there is a need for a processed and packaged meat product that has enhanced moisture retention, thereby eliminating the use of highly absorbent material in the meat package.

### SUMMARY OF THE INVENTION

The present invention is in the field of meat processing and packaging. Specifically, the invention is a packaged uncooked treated meat product and a method of preparing the meat product with increased moisture retention, thereby eliminating the need for highly absorbent material in the package. As used herein “highly absorbent” means that the material can absorb 20 times its weight or more in water. In the meat industry, the term of art to refer to such material in a retail meat package is a “soaker pad.”

In one aspect, the invention is a packaged uncooked treated meat product comprising a portion of uncooked meat selected from the group consisting of poultry, pork or beef, 5 pounds to 25 pounds of a brine solution per 100 pounds of the uncooked meat, wherein the brine solution comprises sodium chloride and sodium carbonate in an amount sufficient to achieve a range of from 0.05 to 1.50 pounds of sodium chloride and from 0.075 to 0.285 pounds of sodium carbonate per 100 pounds of the uncooked meat; and a substantially water impermeable meat package surrounding the uncooked meat, wherein the meat package does not contain a highly absorbent soaker pad; wherein the uncooked meat is impregnated with the brine solution to form an uncooked treated meat product; and wherein the packaged uncooked treated meat product exhibits at least 8% greater moisture retention than an equivalent portion of uncooked untreated meat when cooked under the same conditions.

In the practice of the present invention, the 5% to 25% of the brine solution further comprises 0.2 to 30% of sodium chloride and 0.3 to 5.7% of sodium carbonate.

In another aspect, the substantially water impermeable meat package further comprises a tray upon which the packaged uncooked treated meat product is situated and an overwrap surrounding the meat and the tray. The tray may further comprise molded paper pulp or styrofoam and the overwrap may further comprise cellophane or plastic. The packaged uncooked treated meat product of the present invention may further be packaged with a less absorbent soaker pad.

In addition, the present invention also encompasses a method of processing and packaging meat without a highly absorbent soaker pad comprising the steps of providing a portion of uncooked meat, wherein the uncooked meat is selected from the group consisting of poultry, pork or beef; preparing a dry composition comprising from 0.05 to 1.5 pounds of sodium chloride per 100 pounds of the uncooked meat and from 0.075 to 0.285 pounds of sodium carbonate per 100 pounds of the uncooked meat; dissolving the dry composition in an aqueous liquid to form a liquid brine composition; and treating the portion of uncooked meat with from 5% to 25% by meat weight of the liquid brine composition; and packaging the meat without a highly absorbent soaker pad; wherein the packaged meat exhibits at least 8% greater moisture retention than an equivalent portion of uncooked untreated meat when cooked under the same conditions.

In one aspect, the liquid brine composition of the invention further comprises saccharides or natural flavorings. Further, in various embodiments, treating the portion of uncooked meat with the liquid brine composition may further comprise marinating, injecting or tumbling the meat with the liquid brine composition.

Other aspects of the invention are found throughout the specification.

### DETAILED DESCRIPTION OF THE INVENTION

The present invention is in the field of meat processing and packaging. Specifically, the invention is a packaged uncooked treated meat product and a method of preparing the meat product with increased moisture retention, thereby eliminating the need for highly absorbent material in the package.

In the description that follows, a number of terms used in the field of meat processing and packaging are extensively utilized. In order to provide a clear and consistent understanding of the specification and claims, including the scope to be given such terms, the following non-limiting definitions are provided.

When the terms “one,” “a,” or “an” are used in this disclosure, they mean “at least one” or “one or more,” unless otherwise indicated.

The term “absorbent material” as used herein refers to the material inserted into a package of meat to absorb purge and moisture. This is also referred to as a “soaker pad” in the commercial meat industry. A “highly absorbent soaker pad” is one which is capable of absorbing 20 times or more its weight in water.

The term “aqueous liquid” as used herein refers to any moisture used to dissolve the dry composition into solution. Aqueous liquids include water (liquid or ice), broths (vegetable or animal), natural juices (vegetable, animal or fruit) and blood.

The term “broth” or “broths” as used herein refer to the water in which meat, fish and/or vegetables have been boiled.

The term “dry composition” as used herein refers to a mixture of dry ingredients for processing meats.

The phrase “cooked weight” as used herein refers to the weight of the cooked meat after reaching the desired internal temperature for human consumption.

The term “green weight” as used herein refers to the weight of the meat before processing and cooking.

The term “ingoing percentage” refers to the amount of the dry composition calculated as a percentage of the meat's weight. It is the weight of the dry composition divided by the weight of the liquid brine composition multiplied by the percent addition rate (i.e. Ingoing percentage=((dry composition (lbs.)/total weight of liquid brine composition (lbs.))×(% addition rate)).

The term “injection” as used herein refers to introducing the liquid brine composition into meat by a hollow needle.

The term “liquid brine composition” as used herein refers to the dry composition dissolved in an aqueous liquid such as water, natural juices, broth or blood.

The term “natural juices” as used herein refers to the liquid naturally contained in meat, vegetable or fruit.

The term “natural flavorings” as used herein refers to ingredients such as rosemary extracts, tea extracts, etc. Natural flavorings are foodstuffs considered by the United States Department of Agriculture (“USDA”) and Federal Drug Administration (“FDA”) as natural ingredients.

The term “optional ingredients” as used herein refers to ingredients used in conjunction with or individually with the present invention for function, flavor, and or color.

The term “percent addition rate” as used herein refers to the amount of the liquid brine composition that is applied to the meat during processing. For example, if a 12% addition rate is desired for a 100 pound portion of meat, the meat is processed with a liquid brine composition such that the meat absorbs 12 pounds of the liquid brine composition.

The term “purge” as used herein refers to the moisture emitted from meat after the slaughtering of an animal and the moisture emitted after processing.

The term “tumbler” as used herein refers to a vessel that rotates in a circular motion, at a set speed and time, to facilitate uptake of the liquid brine composition by the meat and usually under vacuum. The term “tumble time” as used herein refers to the amount of time the meat is in the tumbler for processing.

The term “unprocessed meat” as used herein refers to meat not processed with the dry or liquid brine composition of the present invention or any other processing.

The term “yield” as used herein refers to the ratio of cooked weight to green (uncooked) weight. This ratio is greater for processed cooked meat than for unprocessed meat cooked under the same conditions (i.e., same green weight, time and temperature).

Dry Composition

The meat processing compositions of the present invention comprise sodium chloride and sodium carbonate alone or in combination with optional ingredients, such as saccharides and natural flavorings.

In addition to sodium chloride, in some embodiments other salts can easily be substituted. Accordingly, the salt may be a single type of salt or a combination of salts. Types of salt include, but are not limited to: sea salt, kosher salt, rock salt (also known as gray salt) and granulated table salt. Salt substitutes such as potassium chloride, magnesium chloride and potassium lactate also may be utilized.

Sodium carbonate, Na₂CO₃, unlike sodium bicarbonate, which is commonly used as a buffering agent in a variety of commercial foodstuffs, often raises the pH to an undesirable level and is therefore not the alkali source of choice for processing meat. It is commonly thought that the effervescent qualities of sodium bicarbonate make it a better choice over sodium carbonate to enhance moisture retention. However, in the practice of the present invention, this is not the case. Sodium carbonate, at the levels disclosed in the present invention, is unique in its ability to achieve a desired pH without compromising flavor or other qualities of the meat.

Saccharides that may be used in the composition come in a variety of forms including monosaccharides, disaccharides and polysaccharides. They may be utilized to enhance flavor or as a bulking agent. A single type of saccharide or a combination of saccharides may be used in the composition. The types of monosaccharides include glucose, fructose, mannose, galactose, ribose and xylose. Disaccharides include sucrose, lactose, maltose, cellobiose and isomaltose. Polysaccharides include, maltodextrin, dextran, maltodextrose, dextrose, cellulose and starch, as well as polymers of glucose, fructose, mannose, galactose, ribose and xylose. Saccharides may come from a variety of sources ranging from processed table sugar to less processed forms, such as evaporated cane juice, evaporated cane syrup, turbinado sugar, cane extracts or other sweeteners.

Additional optional ingredients that also may be used in the composition include phosphates, nitrates, lactates, acetates, starches, spices, spice extractives, carageenans, sodium bicarbonate, ammonium hydroxide erythorbate, ascorbic acid salts, antioxidants, vinegars, gums, alginates, oil extracts and coloring agents Proteins, such as wheat, milk or soy protein powders may also be included in the composition.

Natural flavorings also may be used in the composition. Many of these flavorings are listed in the USDA or FDA guidelines.

### Types of Meat

The methods and compositions of the present invention may be used to process a variety of meats including, but not limited to poultry, lamb, beef and pork. While muscle tissue is the most common meat processed for consumption, organ tissue can also be processed with the methods and compositions of the present invention.

### Meat Processing

The meat may be processed with the liquid brine composition of the present invention by a variety of methods including injection, dipping, immersion, infusion, perfusion, spraying, tumbling and marinating. These methods may be performed under vacuum, at atmospheric pressure or above and at elevated temperatures, ambient temperature or at reduced temperatures. The methods utilized will vary depending on the type of meat being processed. For example, chicken is generally tumbled, while pork and beef are often injected. Meat processing methods are well known in the food science art and can easily be optimized using known principles of meat processing to achieve the desired moisture retention rate.

The amount of the composition retained by the meat after processing will depend on the type of meat, composition formulation and application method. The present invention can apply up to 25% by meat weight of the liquid brine composition until the meat retains essentially all of the composition. The actual retention rate of a particular composition, for a particular meat under a particular application method, can be determined using routine optimization procedures. Because the difference in the weight of the meat before and after processing will determine the amount of the composition retained, a given composition can be tested with each type of meat, over varying processing periods using different application methods. For example, when applying the desired composition using a tumbler, one can vary the tumble time, tumbler speed and amount of vacuum applied to achieve a particular ingoing addition rate for each type of meat. In general, chicken has a higher ingoing percentage than pork and beef.

### Formulation

The preparation of a liquid brine composition for processing the uncooked meat begins with preparing a dry composition and thereafter dissolving the dry composition in aqueous liquid, forming a liquid brine composition of the desired concentration. Correspondingly, each of the ingredients may be systematically added to the aqueous liquid and dissolved into solution. Aqueous liquids for dissolving the dry composition include, for example, water, a fruit juice, a vegetable juice or broth, a meat juice or broth and blood.

As an aqueous solution, the liquid brine composition is formulated to a specified concentration of each ingredient. The pH of the liquid brine composition may range (or be adjusted with acid or base to range) from 9.0 to 11.0. More specifically, the pH may range from 10.1 to 10.7.

The dry composition is formulated by mixing sodium chloride and sodium carbonate together as a dry blend, along with any optional ingredients. This dry blend is then dissolved in aqueous liquid such that the dry blend is fully dissolved into a liquid brine composition. (Please note that the optional ingredients may be added to the formulation as a dry ingredient, or as a liquid ingredient, either as part of the aqueous solution in which the dry ingredients are dissolved, or separately.)

The amount of dry composition may be calculated based upon the desired percent addition rate and desired ingoing percentage of sodium chloride and sodium carbonate. The percent addition rate refers to the amount of the liquid brine composition that is applied to the meat during processing. For example, if a 12% addition rate is desired for a 100 pound portion of meat, the meat is processed with a liquid brine composition such that the meat absorbs 12 pounds of the liquid brine composition. Correspondingly, the ingoing percentage refers to the amount of the dry composition that is calculated as a percentage of the meat's weight. The volume of aqueous liquid to be used may vary depending on the storage capacity of the machinery used to process the meat. However, where a particular percent addition rate and ingoing percentage are desired, any amount of aqueous liquid may be added so long as the dry composition is fully dissolved in the aqueous liquid.

Therefore, the exact amount of dry composition may be calculated based upon a desired addition rate and ingoing percentage rate, wherein the amount of aqueous liquid is determined based upon the desired processing method. Accordingly, the amount of dry composition can be calculated using the following formula:

$$\frac{X + Y}{X + Y + Z} \times percent addition rate = ingoing percentage$$

wherein X is the amount of sodium chloride;

wherein Y is the amount of sodium carbonate; and

wherein Z is the amount of aqueous liquid to be used.

The desired “salinity” of the processed meat can also be determined by routine optimization. One optimization method is varying the concentration of salt in the composition. For example, a number of compositions containing different salt concentrations can be applied to a particular type of meat using a particular processing method. The meat is then cooked and taste tested for the desired amount of salinity.

Another optimization method is to apply a given composition. Adjusting the amount of the composition applied to the meat. The meat is then cooked and taste tested for the desired amount of salinity. These optimization methods may also be applied to adjust the amount of natural flavorings, artificial flavorings and sweetness (i.e. saccharide concentration) of the meat in order to obtain the desired taste.

The amount of saccharide in the processed meat product may range from 0.05 pounds to 1.5 pounds per 100 pounds of meat. In one embodiment, the amount of saccharide is from 0.1 pounds to 1.0 pounds per 100 pounds of meat.

The amount of natural flavorings in the processed meat product may comprise from 0.001 pounds to 0.1 pounds per 100 pounds of meat. In one embodiment, the amount of natural flavorings ranges from 0.01 pounds to 0.1 pounds per 100 pounds of meat.

### Sample Calculations

The following sample calculations demonstrate how to calculate the exact amount of dry composition comprised of sodium chloride and sodium carbonate that needs to be dissolved in aqueous liquid in order to achieve a desired range of sodium chloride and sodium carbonate in the meat. The formula for determining the appropriate amounts of sodium chloride and sodium carbonate is provided below:

$$\frac{X + Y}{X + Y + Z} \times percent addition rate = ingoing percentage$$

wherein X is the amount of sodium chloride;

wherein Y is the amount of sodium carbonate; and

wherein Z is the amount of aqueous liquid to be used.

Using this formula, the amount of dry composition (X+Y) can be used to calculated the ingoing percentage based upon a desired percent addition rate and desired ingoing percentage of sodium chloride and sodium carbonate in any volume of aqueous liquid.

For example, if 100 pounds of meat are processed according to the present invention and the desired amounts of sodium chloride and sodium carbonate in the processed meat are 1 pound of sodium chloride per 100 pounds of meat and 0.2 pounds of sodium carbonate per 100 pounds of meat, then the ingoing percentage is 1.2% (e.g.) pound of sodium chloride+0.2 pounds of sodium carbonate=1.2 pounds of sodium chloride and sodium carbonate in 100 pounds of processed meat, or 1.2%). Thereafter, if a 15% addition rate is desired and the dry composition is dissolved in 13.8 pounds of aqueous liquid, the calculation for how much dry composition is used is as follows:

$$\frac{X + Y}{X + Y + 13.8 lbs aqueous liquid} \times 15 \% = 1.2 \%$$

where X is the amount of sodium chloride; and

where Y is the amount of sodium carbonate.

$$\frac{1 + .2}{1 + .2 + 13.8 lbs aqueous liquid} \times 15 \% = 1.2 \%$$

$$\frac{1.2 lbs}{15 lbs aqueous composition} \times 15 \% = 1.2 \%$$

In another example, if 20 pounds of meat are processed according to the present invention and the desired amounts of sodium chloride and sodium carbonate in the processed meat are 0.3 pounds of sodium chloride per 20 pounds of meat and 0.05 pounds of sodium carbonate per 20 pounds of meat, then the ingoing percentage is 1.75% (e.g. 0.3 pounds of sodium chloride+0.05 pounds of sodium carbonate=0.35 pounds of sodium chloride and sodium carbonate in 20 pounds of processed meat, or 1.75%). Thereafter, if a 12% addition rate is desired and the dry composition is dissolved an aqueous liquid, the calculation for how much aqueous liquid is used is as follows:

$$\frac{X + Y}{X + Y + Z aqueous liquid} \times 12 \% = 1.75 \%$$

where X is the amount of sodium chloride; and

where Y is the amount of sodium carbonate.

wherein Z is the amount of aqueous liquid to be used.

To determine the amount of aqueous liquid, the following equation is used:
20 lbs of meat times the addition rate minus the dry composition is equal to the aqueous liquid.

(20 lbs×12%)−0.35=2.05 lbs aqueous liquid

Therefore,

$$\frac{X + Y}{X + Y + Z} \times percent addition rate = ingoing percentage$$

wherein X is the amount of sodium chloride;

wherein Y is the amount of sodium carbonate; and

wherein Z is the amount of aqueous liquid to be used.

$$\frac{.3 + .05}{.3 + .05 + 2.05 lbs aqueous liquid} \times 12 \% = 1.75 \%$$

$$\frac{.35}{2.4 lbs aqueous composition} \times 12 \% = 1.75 \%$$

Therefore, in order to treat 20 pounds of meat to achieve, a liquid brine composition of 2.4 pounds is needed. Where 2.05 lbs is the aqueous liquid and 0.35 pounds is the dry composition. 20 pounds of meat is then processed at a percent addition rate of 12% to achieve a 1.75% ingoing percentage of dry ingredients.

In a different example, if 238 pounds of meat are processed according to the present invention and the desired amounts of sodium chloride and sodium carbonate in the processed meat are 0.6 pounds of sodium chloride per 100 pounds of meat and 0.2 pounds of sodium carbonate per 100 pounds of meat, then the ingoing percentage is 0.8% (e.g. 0.6 parts of sodium chloride+0.2 parts of sodium carbonate=0.8% ingoing percentage of dry composition. Thereafter, if a 18% addition rate is desired and the dry composition is dissolved in an aqueous liquid, the calculation for how much dry composition and aqueous liquid is used is as follows:
The amount of dry ingredients is equal to pounds of meat times parts (%) of ingredient.
For sodium chloride, 238 lbs of meat×0.6%=1.428 lbs sodium chloride
For sodium carbonate, 238 lbs of meat×0.2%=0.476 lbs,
Dry composition is equal to X+Y, so 1.428+0.476=1.904 lbs

To determine the amount of aqueous liquid, the following equation is used:
Pounds of meat times the addition rate minus the dry composition is equal to the aqueous liquid.

(238 lbs×18%)−1.904 lbs=40.936 lbs aqueous liquid

Therefore,

$$\frac{X + Y}{X + Y + Z} \times percent addition rate = ingoing percentage$$

wherein X is the amount of sodium chloride;

wherein Y is the amount of sodium carbonate; and

wherein Z is the amount of aqueous liquid to be used.

$$\frac{1.428 + 0.476}{1.428 + 0.476 + 40.936 lbs aqueous liquid} \times 18 \% = 0.8 \%$$

$$\frac{1.904}{42.84 lbs aqueous composition} \times 18 \% = 0.8 \%$$

Based on the above equation and after solving for pounds of sodium chloride, sodium carbonate and the aqueous liquid the result to treat 238 pounds of meat is, 1.428 lbs of sodium chloride is used equal to 0.6%, 0.476 lbs of sodium carbonate is used equal to 0.2% for a total of 0.8% ingoing of dry ingredients and 40.936 lbs of aqueous liquid. For an 18% addition 1.904 lbs of dry ingredients plus 40.936 of aqueous liquid is used equal to 42.84 lbs. 238 lbs of meat plus 42.84 lb of liquid brine composition equals 280.84 lbs. 238 lbs pounds of meat is then processed at a percent addition rate of 18% to achieve a 0.8% ingoing percentage.

### Retail Meat Packaging

Different meat products are likely to exude different amounts of liquid, for example, a lamb chop will exude a small quantity of liquid only, while a chicken for example, may exude a large amount of liquid. Thus, foods normally need to be packed with a suitable amount of absorbency.

Various packaging methods and formats have traditionally been used for packaging meats for retail sales. Trays on which the meat is placed have been manufactured with a wide range of materials depending on a variety of considerations, such as the type of meat and storage conditions. For example, some trays are molded from conventional wood or paper pulp stock which may be formed from water slurry. Other tray manufacturing methods include forming and molding trays from foam plastic or even solid plastics. Other examples of tray forming materials may include polyvinyl, polyethylene, polybutene, polypropylene, polyurethane, polyvinylidene chloride, conventional polystyrene foam, structural cellular polystyrene foam, porous polyolefin material, open cell polystyrene foam and biodegradable foam polystyrene.

Meat pads, referred to as “soaker pads,” generally consist of an upper release layer on which the meat rests, which allows for easy separation of the meat from the pad, and an absorbent lower layer. Soaker pads must be sufficiently absorbent to absorb all the exudates from the meat placed on top thereof so that there is no unsightly pool in the tray, and yet must not leave any type of deposit on the meat. This requires that the soaker pads are sufficiently absorbent (i.e., they are highly absorbent) to hold 20 fold or greater their weight in liquid.

Various examples of soaker pads exist in the prior art of varying complexity. Some soaker pads consist of a simple piece of absorbent paper, whereas others are multi-layered, typically having a release layer and base layer and absorbent material in the middle.

After the meat is placed on a tray, with or without a soaker pad, it is usually sealed or “overwrapped” with a cellophane or plastic wrap, such as SARAN® wrap (S.C. Johnson Companies, Racine, Wis.).

A soaker pad is designed to be a functional, active, absorbent material that exerts capillary forces on the meat to remove and collect moisture from the meat and the surrounding environment. When meat is packaged with a soaker pad, the soaker pad can negatively impact the weight of the meat. In other words, by packaging the meat with a soaker pad, the absorptive properties of the soaker pad can reduce the weight of the meat in the package by as much as 3%. This is because the soaker pad absorbs not only the free liquid in the package, but also continues to absorb the present moisture in the meat as well.

In contrast, meat processed according to the present invention eliminates the need for a soaker pad, thereby eliminating the negative effects on the finished weight of the meat in the package caused by the use of a soaker pad. This is because meat that is not processed according to the method of the present invention will not effectively retain moisture.

Using the compositions of the present invention, the need to include a “highly absorbent soaker pad” is eliminated. This intends that there is no soaker pad in the meat package between the meat and a tray, or between the meat and one of the sides of a bag or other packaging. In conventional uses of soaker pads, the soaker pad usually covers at least 80% of the area of the meat's surface that is next to the soaker pad. Accordingly, sometimes the soaker pad is visible outside of the edges of the meat, and sometimes it is not. However, it is intended that the phrase “without a highly absorbent soaker pad” means that there is no soaker pad having 80% or more of the area of the meat's surface thereupon. Hence, including “half a soaker pad,” which has roughly 50% of the area of the meat's surface next to it is still considered “without a soaker pad.”

### Unexpected Results

It is well known in the industry that uncooked meat, whether or not it has been processed, will continue to exude a certain amount of moisture after packaging, even if it is free of moisture when packaged. This moisture loss is referred to in the industry as “purge.” Thus, when packaged for retail sales, the meat can continue to purge for three or more days inside the packaging. This causes the packaged meat to be undesirable for consumers, since the liquid is visible and often tinged with blood. Hence, the industry has adopted the use of soaker pads for use in many forms of retail packaging.

In the development of the present invention, it was unexpectedly discovered that meat when processed according to the present invention, which uses tightly controlled levels and ratios of salt and sodium carbonate, continued to absorb the moisture that in many cases is present when processors are packaging fresh meat. According to the practices of the present invention it was discovered that this unique process would continue for several hours and in some cases depending on the specious, cut of meat and application for several days while in the retail package, it actually acts like a “sponge” after packaging.

### EXAMPLES

### Example 1

### Preparation of the Uncooked Meat

A liquid brine composition is prepared by adding dry sodium carbonate, sodium chloride and optional dry ingredients to an aqueous liquid such as water. (Note that optional ingredients can be added in liquid form at this time.) After all of the dry ingredients have been fully dissolved in aqueous liquid, uncooked meat is processed with the liquid brine composition at the desired percent addition rate.

Table 1 lists a range of ingredients by percentage amount used to prepare the liquid brine composition based on the pounds of diluent and desired sodium chloride and sodium carbonate content. The uncooked meat is thereafter processed with the liquid brine composition.

TABLE 1
Exemplary Liquid Composition

| | Dry | | | | | | | | | |
|---|---|---|---|---|---|---|---|---|---|---|
| | Ingredients | Pounds of Diluent | | | | | | | | |
| | lbs/100 lbs | 5 | 7.5 | 10 | 12.5 | 15 | 17.5 | 20 | 22.5 | 25 |
| Low End Salt % w/w | 0.050 | 1.000 | 0.667 | 0.500 | 0.400 | 0.333 | 0.286 | 0.250 | 0.222 | 0.200 |
| Low End Sodium | 0.075 | 1.500 | 1.000 | 0.750 | 0.600 | 0.500 | 0.429 | 0.375 | 0.333 | 0.300 |
| Carbonate % w/w | | | | | | | | | | |
| LOW END TOTAL % | 0.125 | 2.500 | 1.667 | 1.250 | 1.000 | 0.833 | 0.714 | 0.625 | 0.556 | 0.500 |
| High End Salt % w/w | 1.500 | 30.000 | 20.000 | 15.000 | 12.000 | 10.000 | 8.571 | 7.500 | 6.667 | 6.000 |
| High End Sodium | 0.285 | 5.700 | 3.800 | 2.850 | 2.280 | 1.900 | 1.629 | 1.425 | 1.267 | 1.140 |
| Carbonate % w/w | | | | | | | | | | |
| HIGH END TOTAL % | 1.785 | 35.700 | 23.800 | 17.850 | 14.280 | 11.900 | 10.200 | 8.925 | 7.933 | 7.140 |

Sodium carbonate and saccharides are obtained from Cooperative, Inc. (Los Angeles, Calif.). Salts, such as sodium chloride are obtained from Industrial Commodities, Inc. (Los Angeles, Calif.) and natural flavorings, such as rosemary extract are obtained from Kalsec Flavor Company, (Los Angeles, Calif.).

### Example 2

### Meat Processing

According to the above example, the quantity of the dry composition ingredients added to the uncooked meat is determined by first deciding on the desired amount of each ingredient necessary to achieve the desired flavor, moisture retention, etc.

The following are examples of how each type of meat can be processed with an exemplary composition.

A. Chicken

To assure that the raw material was from the same slaughter day, boneless, skinless, chicken breasts were obtained from a single forty-pound box. Twenty pounds of the chicken was mixed with a liquid brine composition containing 0.32 pounds of the dry composition ingredients dissolved in 3.68 pounds of water. This was determined based on a desired 20% addition rate and 1.6% of ingoing dry ingredients. The liquid brine composition and the meat were placed in a tumbler and tumbled for approximately 30 minutes at 7 rpms or until all of the composition was absorbed by the meat. The weight of the chicken after tumbling was 24 pounds. The chicken was then divided and placed on eight Styrofoam™ trays. Each tray was filled with 3.0 pounds of chicken, overwrapped with cellophane and refrigerated.

In unprocessed chicken, purge or moisture loss is usually detected within 5 to 72 hours. Therefore, the first tray of eight was examined 72 hours following processing. The chicken was removed and the tray was held perpendicular to and over a scale so that any moisture on the tray was deposited on the scale. No measurable moisture or purge was observed. The remaining seven trays of chicken were examined and measured for moisture or purge over the next seven days, opening one pack per day. No moisture or purge was detected from any of the trays.

In a parallel experiment for comparison purposes, twenty pounds of chicken obtained from the same forty-pound box was packaged without processing. Similarly, the chicken was divided and placed on eight Styrofoam™ trays. Each tray was filled with 2.5 pounds of chicken, overwrapped with cellophane and refrigerated. The first tray of eight was examined 72 hours after processing. The chicken was removed and the tray was held perpendicular to and over a scale so that any moisture would be deposited on the scale. Approximately 0.19 pounds of fluid, or about 7.6% (based on the meat weight) of moisture was observed. Subsequent trays were opened, examined and measured at one tray per day over the next 7 days. The percentage of moisture or purge observed ranged from 5.5% to 12% (based on the meat weight).

Table 2 shows the percent addition rates for chicken based on the ingoing percentage of dry ingredients and the quantity of composition ingredients, water and meat in pounds.

TABLE 2
Percent Addition Rates for Chicken

| Percent | Ingoing % of Dry | Composition | Water in | Meat in |
|---|---|---|---|---|
| Addition Rate | Ingredients | in Pounds | Pounds | Pounds |
| 10% | 1.2% to 1.3% | .24 to .26 | 1.76 to 1.74 | 20 |
| 12% | 1.25% to 1.4% | .25 to .28 | 2.15 to 2.12 | 20 |
| 15% | 1.3% to 1.6% | .26 to .32 | 2.74 to 2.68 | 20 |
| 18% | 1.5% to 1.6% | .30 to .32 | 3.30 to 3.28 | 20 |
| 20% | 1.5% to 1.65% | .30 to .33 | 3.70 to 3.67 | 20 |
| 22% | 1.5% to 1.75% | .30 to .35 | 4.10 to 4.05 | 20 |

B. Beef

Twenty pounds of beef strip steak was mixed with a liquid brine composition, containing 0.27 pounds of dry composition ingredients dissolved in 2.73 pounds of water. This quantity was determined based on a desired 15% addition rate and a 1.35% of ingoing dry ingredients. The meat was infused with the liquid brine composition using an injection system. The meat was then cut into steaks and placed on eight Styrofoam™ trays. Each tray was filled with 2.875 pounds of meat, overwrapped with cellophane and then refrigerated.

In unprocessed beef, purge or moisture is usually detected within 5 to 72 hours. Therefore, the first tray of eight was examined 72 hours after processing. The beef was removed and the tray was held perpendicular to and over a scale so that any moisture would be deposited on the scale. No measurable moisture or purge was observed. Subsequent trays were opened, examined and measured at one tray per day over the next 7 days. No moisture or purge was detected from any of the trays.

Table 3 shows the percent addition rates for beef based on the ingoing percentage of dry ingredients and the quantity of composition ingredients, water and meat in pounds.

TABLE 3
Percent Addition Rates for Beef

| Percent | Ingoing % of Dry | Composition | Water in | Meat in |
|---|---|---|---|---|
| Addition Rate | Ingredients | in Pounds | Pounds | Pounds |
| 10% | 1.2% to 1.3% | .24 to .26 | 1.76 to 1.74 | 20 |
| 12% | 1.25% to 1.4% | .25 to .28 | 2.15 to 2.12 | 20 |
| 15% | 1.3% to 1.6% | .26 to .32 | 2.74 to 2.68 | 20 |
| 18% | 1.5% to 1.6% | .30 to .32 | 3.30 to 3.28 | 20 |
| 20% | 1.5% to 1.65% | .30 to .33 | 3.70 to 3.67 | 20 |
| 22% | 1.5% to 1.75% | .30 to .35 | 4.10 to 4.05 | 20 |
| 25% | 1.5% to 1.8% | .30 to .36 | 4.7 to 4.64 | 20 |

C. Pork

Twenty pounds of center cut pork loin was mixed with a liquid brine composition, containing 0.30 pounds of the composition ingredients dissolved in 3.30 pounds of water. This quantity was determined based on a desired 18% addition rate and 1.5% of ingoing dry ingredients. The meat was infused with the composition using an injection system. The meat was then cut into chops and placed on eight Styrofoam™ trays. Each tray was filled with 2.95 pounds of meat, overwrapped with cellophane and refrigerated.

In unprocessed pork, purge or moisture is usually detected within 5 to 72 hours. The first tray of eight was examined 72 hours after processing. The pork was removed and the tray was held perpendicular to and over a scale so that any moisture was deposited on the scale. No measurable moisture or purge was observed. Subsequent trays were opened, examined and measured at one tray per day over the next 7 days. No moisture or purge was detected from any of the trays.

Table 4 shows the percent addition rates for pork based on the ingoing percentage of dry ingredients and the quantity of composition ingredients, water and meat in pounds.

TABLE 4
Percent Addition Rates for Pork

| Percent | Ingoing % of Dry | Composition | Water in | Meat in |
|---|---|---|---|---|
| Addition Rate | Ingredients | in Pounds | Pounds | Pounds |
| 8% | 1.1% to 1.3% | .22 to .26 | 1.38 to 1.34 | 20 |
| 10% | 1.2% to 1.3% | .24 to .26 | 1.76 to 1.74 | 20 |
| 12% | 1.25% to 1.4% | .25 to .28 | 2.15 to 2.12 | 20 |
| 15% | 1.3% to 1.6% | .26 to .32 | 2.74 to 2.68 | 20 |
| 18% | 1.5% to 1.6% | .30 to .32 | 3.30 to 3.28 | 20 |

These results indicate that meat processed by the methods of the present invention did not lose moisture during storage under refrigeration. These results were unexpected because conventional thought suggests that if more moisture is added to meat, it will merely result in additional moisture loss after packaging. It is this fact that drives the meat packaging industry to use highly absorbent materials to soak-up moisture or purge from meat after packaging. In contrast, by using the methods and composition of the present invention, moisture can be added to the meat without subsequent moisture loss and the need for absorbent materials is reduced or eliminated.

### Example 3

### Taste Panel

A taste test panel of 13 volunteers was assembled. The volunteers consumed both processed and unprocessed meat and completed questionnaires. The questions asked their opinion as to saltiness, sweetness, chemical taste, acidic taste or sourness, natural chicken flavor, overall chicken flavor, intensity of chicken flavor and whether the chicken tasted processed. The questionnaire also included a section for comments as to the reasons for their selection. The response scale ranged from 1 to 10, wherein a score of 1 or 2 was considered indifferent and within a desirable target range and a score of 9 or 10 was considered over-powering and undesirable.

The chicken breasts from day four in the moisture purge test, in section “A” above, were subjected to the taste panel. Both the processed and unprocessed chicken packages were cooked to an internal temperature above 170° F. Results collected from the questionnaires found that 12 of the 13 panel members scored the processed chicken as desirable. The taste panel's answers and comments indicated that they preferred the processed chicken because it was more moist and tender.

The examples set forth above are provided to give those of ordinary skill in the art with a complete disclosure and description of how to make and use the embodiments of the methods, and are not intended to limit the scope of what the inventor regards as his invention. Modifications of the above-described modes (for carrying out the invention that are obvious to persons of skill in the art) are intended to be within the scope of the following claims. All publications, patents and patent applications cited in this specification are incorporated herein by reference as if each such publication, patent or patent application were specifically and individually indicated to be incorporated herein by reference.

What is claimed is:

1. A packaged uncooked treated meat product comprising:
a) a portion of uncooked meat selected from the group consisting of: poultry, pork, lamb, and beef;
b) 5 lbs to 25 lbs of a brine solution per 100 lbs of the uncooked meat, wherein the brine solution comprises sodium chloride and sodium carbonate in an amount sufficient to achieve a range of from 0.05 to 1.50 pounds of sodium chloride and from 0.075 to 0.285 pounds of sodium carbonate per 100 pounds of the uncooked meat and wherein the pH of the brine solution is between 10.1 and 10.7; and
c) a substantially water impermeable meat package surrounding the uncooked meat, wherein the meat package does not contain a soaker pad and wherein the meat package comprises a single-layer, Out bottom, waterproof tray;
wherein the uncooked meat is impregnated with the brine solution to form an uncooked treated meat product; and
wherein the packaged uncooked treated meat product exhibits at least 8% greater moisture retention than an equivalent portion of untreated meat packaged under the same conditions.

2. The packaged uncooked treated meat product of claim 1, wherein the meat is poultry.

3. The packaged uncooked treated meat product of claim 1, wherein the meat is pork.

4. The packaged uncooked treated meat product of claim 1, wherein the meat is beef.

5. The packaged uncooked treated meat product of claim 1, wherein the 5 to 25 lbs of brine solution further comprises 0.2 to 30% of sodium chloride and 0.3 to 5.7% of sodium carbonate.

6. (canceled)

7. (canceled)

8. The packaged uncooked treated meat product of claim 1, wherein the meat package further comprises an overwrap comprising cellophane or plastic.

9. (canceled)

10. A method of processing and packaging meat without a soaker pad, said method comprising the steps of:
a) providing a portion of uncooked meat, wherein the uncooked meat is selected from the group consisting of: poultry, pork, lamb, and beef;
b) preparing a dry composition comprising: from 0.05 to 1.50 pounds of sodium chloride per 100 pounds of the uncooked meat; and from 0.075 to 0.285 pounds of sodium carbonate per 100 pounds of the uncooked meat;
c) dissolving the dry composition in an aqueous liquid to form a liquid brine composition wherein the pH of the brine solution is between 10.1-10.7;
d) treating the portion of uncooked meat with from 5% to 25% by meat weight of the liquid brine composition from step c); and
e) packaging the meat from step d) without a soaker pad and wherein the meat package comprises a single-layer flat bottom, waterproof tray;
wherein the packaged uncooked treated meat product from step e) exhibits at least 8% greater moisture retention than an equivalent portion of uncooked untreated meat packaged under the same conditions.

11. The method of claim 10, wherein the liquid brine in step c) further comprises 0.2 to 30% of sodium chloride and 0.3 to 5.7% of sodium carbonate.

12. The method of claim 10, wherein the liquid brine composition further comprises saccharides or natural flavorings.

13. The method of claim 10, wherein the liquid brine composition further comprises at least one additional ingredient selected from the group consisting of: phosphates, nitrates, lactates, acetates, starches, diacetates, spices, carageenans, sodium bicarbonate, sugars, dextrins, sea salt, maltodextrin, ammonium hydroxide, erythorbate, ascorbic acid salts, antioxidants, vinegars, gums, broths, alginates, oil extracts, coloring agents and proteins.

14. The method of claim 10, wherein step d) further comprises marinating, injecting or tumbling the meat with the liquid brine composition.

15. (canceled)

16. The packaged uncooked treated meat product of claim 1, wherein the meat is lamb.
